(19) United States
(12) Patent Application Publication
(10) Pub. No.: US 2026/0249761 A1
(43) Pub. Date: Aug. 27, 2026

(54) ARMREST DEVICE FOR A VEHICLE INTERIOR

(71) Applicant: BOS GmbH & Co. KG, Ostfildern (DE)

(72) Inventor: Andreas GÖBBELS, Kürten (DE)

(21) Appl. No.: 19/540,892

(22) Filed: Feb. 16, 2026

(30) Foreign Application Priority Data
Feb. 21, 2025 (DE) 102025106665.5

(51) Int. Cl. B60N 2/75

(52) U.S. Cl. CPC B60N 2/767; B60N 2/793

(57) ABSTRACT

An armrest for a vehicle interior having a console, an armrest part mounted liftably relative to the console, a lifting drive to move the armrest part between different positions relative to the console and to lock the armrest part in the respective position, and a panel structure projecting downwards from the armrest part and which drops into the console in a lower position of the armrest part and conceals an intermediate space between the armrest part and the console in an upper position. A lid is arranged on an upper side of the armrest part and is movable between a closed position and an open position. A storage compartment is provided on the armrest part, projects downwards from the armrest part and has a fully closed floor, and walls of the storage compartment form the panel structure or are set at a distance inwards relative to the panel structure.

### CROSS-REFERENCE TO RELATED APPLICATION

This claims priority from German Application No. 102025106665.5, filed Feb. 21, 2025, the disclosure of which is hereby incorporated by reference in its entirety.

### TECHNICAL FIELD

The invention relates to an armrest device for a vehicle interior, with a console fixed to the vehicle in the state fitted ready for operation; with an armrest part which is mounted liftably relative to the console; with a lifting drive to move the armrest part between different lifting positions relative to the console and to lock the armrest part in the respective lifting position; with a panel structure projecting downwards from the armrest part and which drops into the console in a lower lifting position of the armrest part and conceals an intermediate space between the armrest part and the console in an upper lifting position of the armrest part; and with at least one lid which is arranged on the upper side of the armrest part and is movable between a closed position and an open position.

### BACKGROUND AND SUMMARY

An armrest device of this type is known from DE 10 2020 203 129 A1. The known armrest device has a console fittable fixed to the vehicle, which in the state fitted ready for operation is arranged between a driver seat and a passenger seat. An armrest part is mounted liftably on the console, wherein the armrest part is mounted swivelably relative to the console about a swivel axis extending in the transverse direction of the vehicle in order to reach different lifting positions. The armrest part has a frame and a lid mounted swivelably on the frame. The frame forms a storage compartment for items to be stowed. A panel structure which is liftable together with the armrest part is provided on the armrest part. The panel structure conceals an intermediate space between the armrest part and the vehicle-fixed console in every lifting position of the armrest part.

One object of the invention is to provide an armrest device of the type mentioned at the outset which is an improvement on the prior art.

This is achieved in that a storage compartment, which projects downwards starting from the armrest part and is provided with a fully closed floor, is provided on the armrest part, wherein all-round walls of the storage compartment form the panel structure or are at a distance inwards relative to the panel structure. The storage compartment has a depth which at least largely corresponds to a maximum lifting distance of the armrest part between a lower end position and an upper end position. The fully closed floor ensures that no items to be stowed can become lost in the deeper parts of the console. The at least one lid is used to close off or expose the storage compartment. The storage compartment may form a single large compartment area or be subdivided into different storage compartment areas. The at least one lid is preferably mounted swivelably on the armrest part and locked in its closed position. The lid can also be formed by two lid parts which swivel up and outwards towards opposite sides like butterfly wings. A swivel axis of the at least one lid extends, in the state fitted ready for operation, preferably substantially in the longitudinal direction of the vehicle, while a swivel axis of the armrest part advantageously extends substantially in the transverse direction of the vehicle, such that a lid swivel axis is oriented orthogonally to the swivel axis of the armrest part. If the all-round walls of the storage compartment form the panel structure, the storage compartment has a dual function. It then Serves on the one hand for stowage of items and on the other hand for covering the intermediate space between the armrest part and the console, depending on the lifting position of the armrest part. The solution according to the invention is suitable in an advantageous manner for a vehicle interior of a passenger car. In the same way, the armrest device in accordance with the invention can also be used in vehicle interiors of trucks or commercial vehicles.

In one embodiment of the invention, the storage compartment is held removably inside the armrest part. This embodiment is advantageous for enabling easy cleaning of the storage compartment. The storage compartment is formed by a dimensionally stable and in particular box-like or cup-like container.

In a further embodiment of the invention, the floor of the storage compartment is supported on its underside by a carrier construction. This carrier construction is firmly connected to a supporting structure of the armrest part and reinforces the floor of the storage compartment in that the carrier construction is positioned on the underside of the floor and supports the floor downwards. Advantageously, the carrier construction is designed bracket-like, wherein corresponding bracket members are preferably oriented orthogonally to one another and hug opposite outer walls of the storage compartment and the floor of the storage compartment on the underside. This allows heavy items too to be received in the storage compartment without any risk of the storage compartment breaking through into the interior of the console.

In a further embodiment of the invention, an actuating element is provided on the armrest part for activation of the lifting drive. The actuating element is preferably a manually operable button which is in an operative connection to the lifting drive. Advantageously, a mechanical lifting drive is provided as the lifting drive.

In a further embodiment of the invention, an operating element is provided on the armrest part for opening the at least one lid. The operating element is preferably designed as a manually operable button element and interacts with a locking mechanism of the lid such that the lock is released when the operating element is manually actuated. Advantageously, a spring device is associated with the at least one lid and swivels the at least one lid by force into an open position after unlocking.

In a further embodiment of the invention, the armrest part is mounted swivelably on the console, wherein a swivel axis is provided on an end region of the armrest part. The swivel axis is, in the state fitted ready for operation of the armrest device in the vehicle interior, advantageously oriented in the transverse direction of the vehicle. The swivel axis can here be provided on the end region of the armrest part, on the front or on the rear. A corresponding lifting movement of the armrest part is accordingly a swivel movement.

In a further embodiment of the invention, the lifting drive is positioned opposite to the swivel axis on the armrest part. A maximum possible leverage for movement of the armrest part is thus achieved for the lifting drive.

In a further embodiment of the invention, the lifting drive has at least one pinion mounted rotatably on the armrest part, and at least one rack which is curved concentrically in a circular arc shape relative to the swivel axis, positioned on the console and fixed to the vehicle. The rack defines, in conjunction with the pinion that meshes with the rack, the circular arc-shaped swivel movement for lifting the armrest part.

In a further embodiment of the invention, a mechanical spring drive is associated with the pinion for permanent application of a torque to the pinion. The mechanical spring drive applies a torque which is greater than a weight force, acting in the opposite direction, of the armrest part such that the spring drive permanently forces the armrest part towards an upper end position in the lifting direction.

In a further embodiment of the invention, the lifting drive has a braking device, in particular a wrap spring brake, which blocks the pinion against the torque of the spring drive, and the actuating element is coupled to the braking device. The braking device keeps the armrest part in a desired lifting position against the permanent driving force of the mechanical spring drive. A movement of the armrest part is thus effected manually by operation of the actuating element that releases the braking device. When the braking device is released, the armrest part moves into its upper end position, unless a manual actuating force is applied in the opposite direction by an operator, in particular by the arm of an operator resting on the armrest part. The armrest part is, after release of the braking device, i.e. by manual pressure, accordingly forced back into the lower lifting position against the driving force of the spring drive. After removing a corresponding manual load on the actuating element, the braking device engages again, so that the armrest part is again blocked in the appropriately adjusted lifting position.

Further advantages and features of the invention can be found in the claims and in the following description of a preferred example of the invention explained on the basis of the drawings.

### BRIEF DESCRIPTION OF THE DRAWINGS

FIG. 1 shows in a side view an embodiment of a armrest device in accordance with the invention in a lower lifting position,

FIG. 2 shows the armrest device according to FIG. 1, but in an upper lifting position,

FIG. 3 shows a front view of the armrest device according to FIG. 1,

FIG. 4 shows a front view of the armrest device according to FIG. 2,

FIG. 5 shows a longitudinal section through the armrest device according to FIGS. 2 and 4,

FIG. 6 shows a cross-section through the armrest device according to FIGS. 1 to 5 with the lid parts closed,

FIG. 7 shows the cross-section according to FIG. 6, but with the lid parts opened,

FIG. 8 shows a further cross-sectional view of the armrest device according to FIGS. 1 to 7 in a lower lifting position according to FIG. 1 and

FIG. 9 shows a cross-sectional view similar to FIG. 8, but in an upper lifting position of the armrest device.

### DETAILED DESCRIPTION

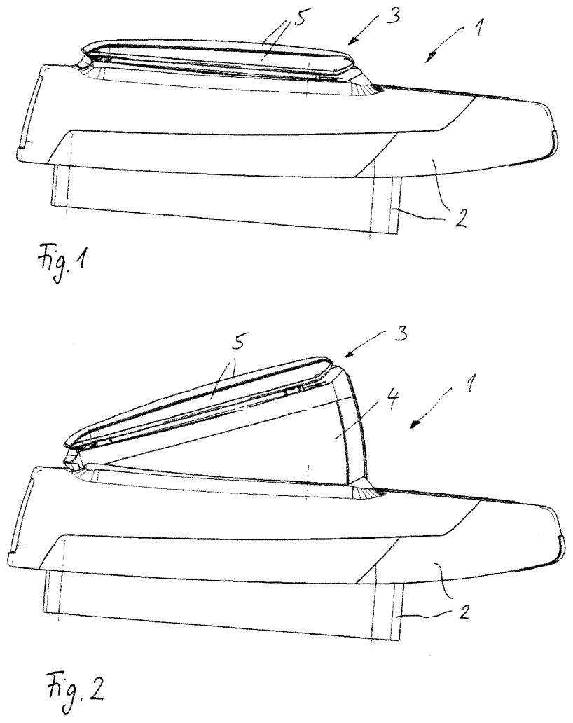

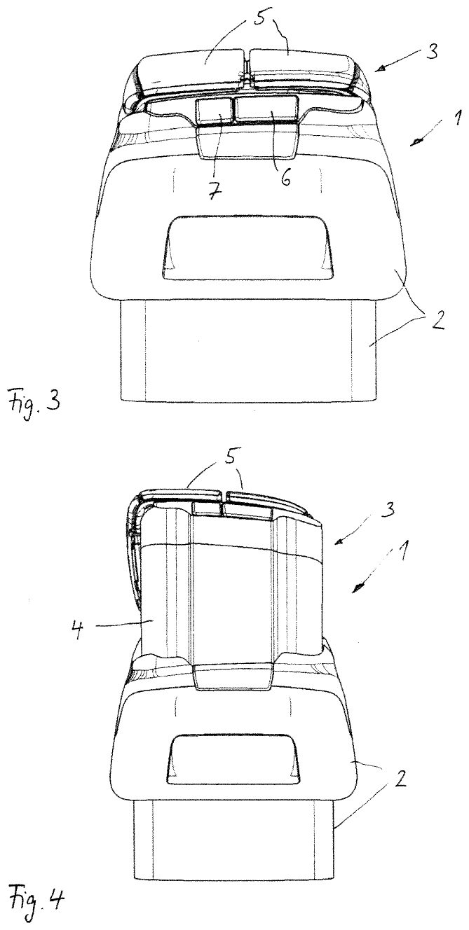

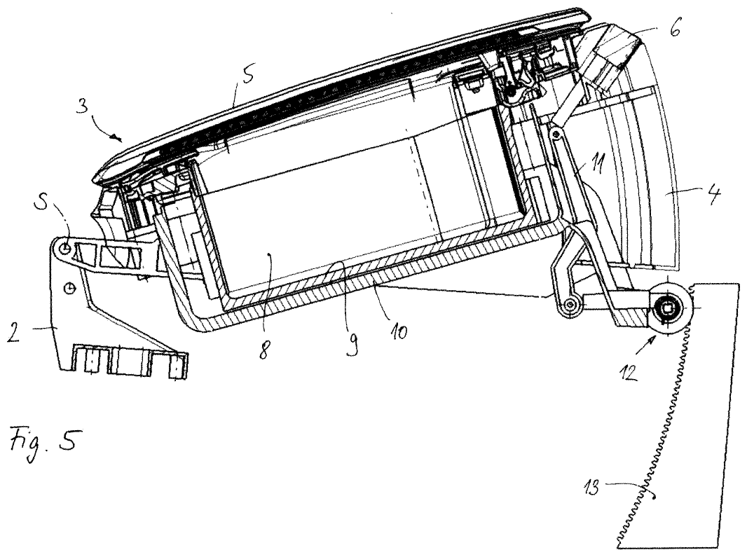

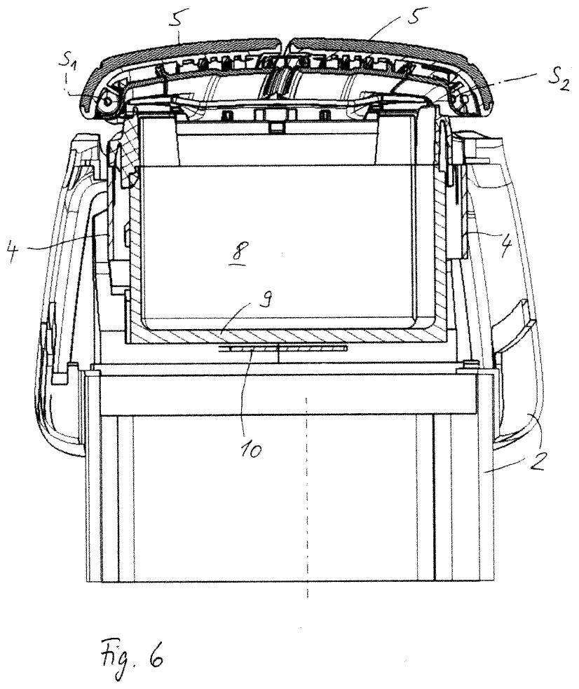

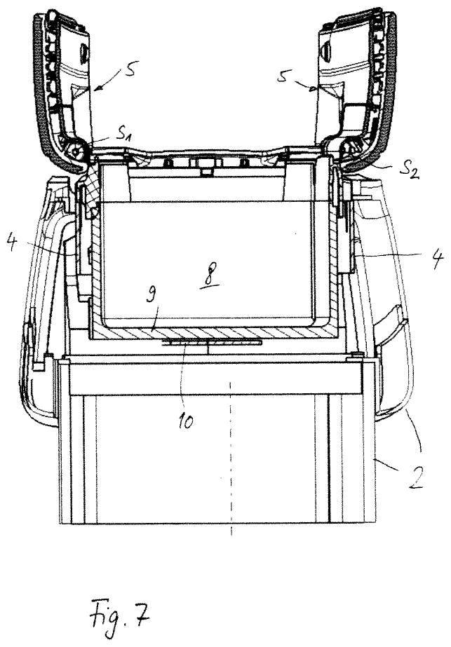

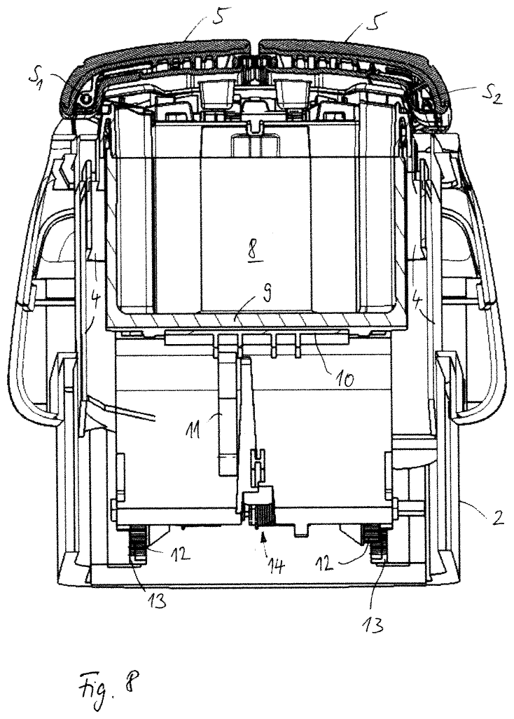

An armrest device 1 according to FIGS. 1 to 9 is, in the state fitted ready for operation, fitted to the vehicle in a vehicle interior of a passenger car between two front seats. The armrest device 1 extends in its orientation in the longitudinal direction of the vehicle. In the view according to FIGS. 1 and 2, a normal travel direction of the passenger car is to the right, such that the right-hand side of the drawing refers to the front and the left-hand side refers to the rear.

A passenger car has a vehicle interior provided with two front seats. One front seat is designed as the driver seat, the other front seat as the passenger seat. Between the two front seats, an armrest device 1 according to FIGS. 1 to 9 is provided which extends substantially in the longitudinal direction of the vehicle and is mounted on a center console of the vehicle interior. The armrest device 1 has a console 2, which may be part of the center console, fixed to the vehicle in the state fitted ready for operation.

An armrest part 3 is held liftably on the console. FIG. 1 shows a lower lifting position of the armrest part 3, and FIG. 2 an upper lifting position of the armrest part 3. The lower lifting position and the upper lifting position, as may be discerned from FIGS. 1 and 2, each form end lifting positions for the armrest part 3, so that these end positions define a maximum lifting distance of the armrest part 3.

As may be readily discerned from FIG. 5, the liftability of the armrest part 3 relative to the vehicle-fixed console 2 is achieved by the armrest part 3 being mounted swivelably on the console 2. The armrest part 3 has a dimensionally rigid supporting structure, not indicated in detail, which is mounted swivelably on an end region, in the present case on a rear end region of the armrest part 3, about a swivel axis S on the console 2. The swivel axis S extends, in the state fitted ready for operation of the armrest part 3 and of the console 2, in the transverse direction of the vehicle and hence orthogonally to a longitudinal extent of the armrest device 1. Since the swivel axis S is mounted swivelably on a rear end region of the armrest part 3, in particular its supporting structure, the armrest part 3 rotates about the swivel axis S out of the lower lifting position according to FIG. 1 and upwards into the upper end position according to FIG. 2.

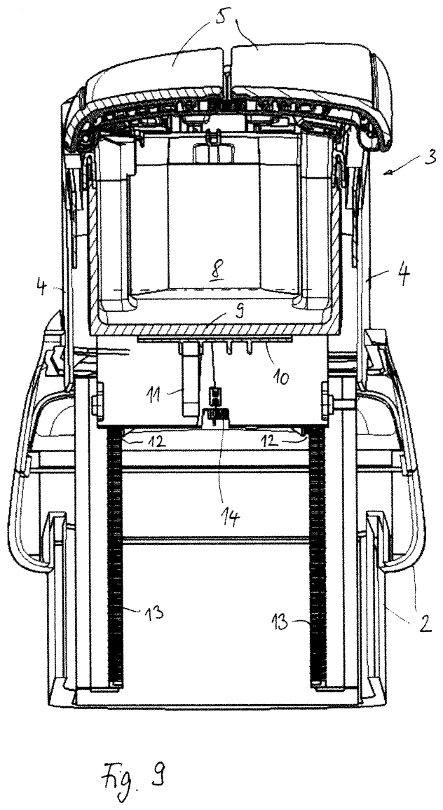

To swivel the armrest part 3, a lifting drive is provided which has two pinions 12 which are mounted rotatably parallel to one another about a rotation axis mounted rotatably relative to the swivel axis S. The pinions 12 are mounted rotatably on a front lower end region of the supporting structure of the armrest part 3 and hence opposite to the swivel axis S. The two pinions 12 mesh with two circular arc-shaped racks 13 (see also FIGS. 8 and 9) which are arranged fixed to the vehicle in the region of the console 2. The two racks 13 are positioned in the transverse direction of the vehicle parallel and at a distance to one another and curving concentrically about the swivel axis S. During a swivel movement of the armrest part 3, the two pinions 12 thus mesh with the associated racks 13. In a manner not shown in detail, a spring drive is associated with the two pinions 12 and permanently subjects the two pinions 12 to a torque in a direction of rotation that effects a rolling action of the pinions 12 along the racks 13 in the upward lifting direction. As shown according to FIG. 5, the spring drive thus leads to the two pinions 12 being rotated clockwise.

A braking device 14 (FIGS. 8 and 9) is also associated with the two pinions and disables the spring drive, thus blocking the pinions 12 relative to the racks 13. This braking device 14, which is designed as a wrap spring brake coaxial to a rotation axis of the pinions 12, is released or blocked by an actuating linkage 11, depending on the movement direction of the actuating linkage 11. The actuating linkage 11 is acted on by a manually operable actuating element 6 which is mounted to be linearly movable in the armrest part 3 in the manner of a pushbutton and can be operated by applying pressure to it. A resetting spring, not shown, resets the actuating element 6 back into the non-loaded initial position once the manual pressure has been removed. Manual pressing of the actuating element 6 leads to a release of the braking device 14, whereby the driving force of the spring drive moves the pinions 12 and hence the armrest part 3 upwards. As soon as a pressure is exerted from above onto the armrest part 3 by an operator, the armrest part 3 can also be forced back downwards, against the driving force of the spring drive, by an operator. This is however only possible when the actuating element 6 is pressed, i.e. when the braking device 14 is released. As soon as the braking device 14 is blocking the pinions 12 again, the armrest part 3 is necessarily blocked in the correspondingly adjusted lifting position.

As may be discerned from FIGS. 3 to 7, the armrest part 3 is closed in the area of its upper side by two lid parts 5 which are mounted movably between a closed position and an open position about two swivel axes S1 and S2. The two swivel axes S1 and S2 extend parallel to one another substantially in the longitudinal direction of the vehicle, and hence orthogonally to the swivel axis S of the armrest part 3. The two lid parts 5 are swivelable up and outwards like butterfly wings, wherein the two swivel axes S1 and S2 are positioned on opposite longitudinal edge areas of the supporting structure of the armrest part 3. A locking device, not shown in detail, locks the lid parts 5 in their closed position. The operating button 7 is used to unlock the locking device, in that pressure is applied manually to the operating button 7 by an operator. In the area of the two swivel axes Si and S2 torsion springs, not shown in detail, are provided which each exert a torque on the lid parts 5 in the opening direction. Closing of the lid parts 5 from their respective open positions is achieved manually by an operator against the opening force of the respective torsion springs.

In order to prevent, during upward swiveling of the supporting structure of the armrest part 3, a view into an intermediate space between the supporting structure 3 of the armrest part 3 and console 2, a panel structure 4 is additionally provided on the armrest part 3. The panel structure 4 is formed by several wall sections which surround the supporting structure in the manner of a box closed at the sides and also at the front. The panel structure 4 is fastened to the supporting structure of the armrest part 3, such that the panel structure 4 is also swiveled upwards when the armrest part 3 is swiveled up, as may be readily discerned from FIGS. 2, 4, 5, 8, 9. The panel structure has wall sections made of plastic which project inwards into a receiving area, not indicated in detail, of the console 2.

In the interior of the panel structure 4, the armrest part 3 is provided with a box-like or cup-like storage container 8 that forms a storage compartment in the meaning of the invention. The storage container 8 is firmly connected to the supporting structure of the armrest part 3, wherein the storage container 8 can be held detachably in the supporting structure of the armrest part 3. A depth of the storage container 8 corresponds at least largely to a maximum lifting distance of the armrest part 3 between the lower and upper lifting positions. The storage container 8 has a fully closed container floor 9. Side walls of the storage container 8 extend at least largely parallel to opposite lateral wall sections of the panel structure 4, offset inwardly and at a short distance relative to the panel structure 4. The container floor 9 is supported downwards in the vertical direction of the vehicle by a carrier construction 10, which is designed bracket-like and is part of the supporting structure of the armrest part 3. The bracket-like carrier construction 10 grips underneath the container floor 9 in the middle and extends substantially in the longitudinal direction of the armrest part 3. The carrier construction 10 also has guide sections for the actuating linkage 11.

The storage container 8 acting as the storage compartment is open to the top. The two lid parts 5 are intended to close or expose this opening of the storage container 8 in the armrest part 3.

1. An armrest device for a vehicle interior, comprising:
a console fixed to the vehicle in a state fitted and ready for operation; with
an armrest part mounted liftably relative to the console;
with a lifting drive to move the armrest part between different lifting positions relative to the console and to lock the armrest part in a respective lifting position; with
a panel structure projecting downwards from the armrest part and dropping into the console in a lower lifting position of the armrest part and concealing an intermediate space between the armrest part and the console in an upper lifting position of the armrest part; and with
at least one lid arranged on an upper side of the armrest part and movable between a closed position and an open position; and
a storage compartment provided on the armrest part and projecting downwards starting from the armrest part, the storage compartment including a fully closed floor and walls surrounding the floor, the walls forming the panel structure or being located at a distance inwards relative to the panel structure.

2. The armrest device according to claim 1, wherein the storage compartment is held removably inside the armrest part.

3. The armrest device according to claim 1, further including a carrier construction, and floor of the storage compartment has an underside supported by the carrier construction.

4. The armrest device according to claim 1, further comprising an actuating element on the armrest part for activation of the lifting drive.

5. The armrest device according to claim 1, further including at least one lid and an operating element disposed on the armrest part for opening the at least one lid.

6. The armrest device according to claim 1, wherein the armrest part is mounted swivelably on the console, and an end region of the armrest part defines a swivel axis.

7. The armrest device according to claim 6, wherein the lifting drive is positioned opposite to the swivel axis on the armrest part.

8. The armrest device according to claim 6, wherein the lifting drive has at least one pinion mounted rotatably on the armrest part, and at least one rack curved concentrically in a circular arc shape relative to the swivel axis and positioned on the console and fixed to the vehicle.

9. The armrest device according to claim 8, further comprising a mechanical spring drive associated with the at least one pinion for permanent application of a torque to the at least one pinion.

10. The armrest device according to claim 9, further comprising an actuating element on the armrest part for activation of the lifting drive, the lifting drive has a braking device blocking the at least one pinion against the torque of the spring drive, and the actuating element is coupled to the braking device.

11. The armrest device according to claim 10, wherein the braking device comprises a wrap spring brake.
